(19) United States
(12) Patent Application Publication
(10) Pub. No.: US 2013/0198091 A1
(43) Pub. Date: Aug. 1, 2013

(54) SYSTEM OF ALTERNATIVE DISPUTE RESOLUTION IMPLEMENTED THROUGH A GLOBAL COMPUTER NETWORK AND METHODS THEREOF

(71) Applicant: Daniel Jahnsen, Brielle, NJ (US)

(72) Inventor: Daniel Jahnsen, Brielle, NJ (US)

(21) Appl. No.: 13/756,081

(22) Filed: Jan. 31, 2013

Related U.S. Application Data
(60) Provisional application No. 61/593,253, filed on Jan. 31, 2012.

(51) Int. Cl. G06Q 50/18; G06Q 40/00

(52) U.S. Cl. CPC G06Q 50/182; G06Q 40/00
USPC 705/309

(57) ABSTRACT

A computer-implemented method for alternative dispute resolution is provided. In exemplary embodiments, the method may comprise, at a computing device having one or more processors and memory storing one or more programs for execution by the one or more processors, receiving a legal claim and an associated data profile from a first user, receiving first user merit data from the first user, the first user merit data comprising data associated with the merits of the legal claim, receiving second user merit data from a second user, the second user merit data comprising data associated with the merits of the legal claim, generating a settlement number for the first user based on the first user merit data, generating a settlement number for the second user based on the second user merit data, and notifying the first user and the second user that settlement is likely if the settlement number for the first user and the settlement number for the second user are within an acceptable range.

### CROSS-REFERENCE TO RELATED APPLICATIONS

The present application claims priority to U.S. Provisional Patent Application Ser. No. 61/593,253 entitled “System of Alternative Dispute Resolution Implemented Through a Global Computer Network and Methods Thereof,” filed Jan. 31, 2012, the disclosure of which is incorporated herein by reference in its entirety.

### BACKGROUND

1. Field of the Invention

Embodiments of the present invention generally relate to a system of alternative dispute resolution implemented through a global computer network and methods thereof. More specifically, embodiments of the present invention relate to a system and method designed to facilitate the early adjustment and resolution of litigated matters and to provide its users with objective parameters of settlement claims.

2. Description of Related Art

Since the inception of legal tribunals, courtroom trials have been the most effective means through which to resolve legal controversies. However, due to the proliferation of litigation, and the overburdened court system, litigants face protracted delay in bringing their cases to trial which results in increased cost to all parties. In recent years there has been progress with methods of resolution that diverge from traditional litigation, called alternative dispute resolution (“ADR”). However, the process lacks a the tools necessary to identify and expedite cases ripe for resolution and, often, when dealing with difficult or uneducated parties, whose demands are unreasonable in view of the relevant facts of their case, can be an additional burden, which results in ending up in a courtroom anyway.

Many cases, where many of the facts and/ or the responsible party are not in dispute, are ripe for settlement. However, such cases do not often get resolved through traditional ADR because either one or both parties are too inexperienced, or too overzealous to find a reasonable middle ground—one which may be likely to be found by a court of law. Additionally, the psychological barriers to effective negotiation often result in parties maintaining unreasonable positions, or injecting competitive forces into a process which produces better results when parties work collaboratively.

Thus, there is a need for a system of alternative dispute resolution implemented through a global computer network and methods thereof. Its purpose is to identify, facilitate, and expedite resolution of cases, and provide tools and information useful to formulate reasonable positions, and promote accountablility to clients that their best interests are being served.

### SUMMARY

Embodiments of the present invention generally relate to a system of alternative dispute resolution implemented through a global computer network and methods thereof. In one embodiment, a computer-implemented method for alternative dispute resolution is provided comprising, and may comprise, at a computing device having one or more processors and memory storing one or more programs for execution by the one or more processors, receiving a legal claim and an associated data profile from a first user; receiving first user merit data from the first user, the first user merit data comprising data associated with the merits of the legal claim; receiving second user merit data from a second user, the second user merit data comprising data associated with the merits of the legal claim; generating a settlement number for the first user based on the first user merit data generating a settlement number for the second user based on the second user merit data; and notifying the first user and the second user that settlement is likely if the settlement number for the first user and the settlement number for the second user are within an acceptable range.

In another embodiment of the present disclosure, a computer-implemented method for alternative dispute resolution is provided, and may comprise, at a computing device having one or more processors and memory storing one or more programs for execution by the one or more processors, generating and storing a first user account associated with a first user and a second user account associated with a second user, wherein at least one of the first user and the second user is required to submit payment and activate a subscription in order to access the method; receiving a legal claim and an associated data profile from the first user; receiving first user merit data from the first user, the first user merit data comprising data associated with the merits of the legal claim; receiving second user merit data from the second user, the second user merit data comprising data associated with the merits of the legal claim; granting access to the first user merit data only to the first user; granting access to the second user merit data only to the second user generating a settlement number for the first user based on the first user merit data generating a settlement number for the second user based on the second user merit data; notifying the first user and the second user that settlement is likely if the settlement number for the first user and the settlement number for the second user are within an acceptable range; and notifying the first user and the second user that settlement is not likely if the settlement number for the first user and the settlement number for the second user are not in the acceptable range.

In yet another embodiment of the present disclosure, a computer-implemented method for alternative dispute resolution is provided, and may comprise, at a computing device having one or more processors and memory storing one or more programs for execution by the one or more processors, receiving a legal claim and an associated data profile from a first user; providing a range of suggested settlement numbers to the first user based on data related to the legal claim previously collected from other users; receiving first user merit data from the first user, the first user merit data comprising data associated with the merits of the legal claim; receiving second user merit data from a second user, the second user merit data comprising data associated with the merits of the legal claim; generating a settlement number for the first user based on the first user merit data; generating a settlement number for the second user based on the second user merit data; notifying the first user and the second user that settlement is likely if the settlement number for the first user and the settlement number for the second user are within an acceptable range; notifying the first user and the second user that settlement is not likely if the settlement number for the first user and the settlement number for the second user are not in the acceptable range; and notifying at least one of the first user and the second user that at least one of the first user and the second user should reconsider their settlement position if the settlement number for the first user and the settlement number for the second user are within a percentage of the acceptable range.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a block diagram of an exemplary system in accordance with one embodiment of the present disclosure;

FIG. 2 depicts a block diagram of a general computer system in accordance with one embodiment of the present disclosure; and

FIG. 3 depicts a flowchart of a method of alternative dispute resolution utilizing an exemplary embodiment in accordance with embodiments of the present disclosure.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present disclosure generally relate to a system of alternative dispute resolution implemented through a global computer network and methods thereof. More specifically, embodiments of the present disclosure relate to a system and method designed to facilitate the early adjustment and resolution of litigated matters and to provide its users with objective parameters of settlement claims.

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present disclosure, as other equally effective examples are possible and likely.

As used herein, the term “multimedia data” refers to any type of data that may reasonably be construed as a media data type, including specifically, audio data (e.g., sound bites, music, or the like), visual data (e.g., photographs, graphics, videos, or the like), text data (e.g., as entered by a user from an input device), barcode data (e.g., as commonly found on tickets, labels, or the like), radio frequency identification (RFID) data, geographic and/or directional data (e.g., as reported from a Global Positioning System (GPS) or a preprogrammed routing source, often in the form of coordinates, or relationship positioning), or the like. As understood by the embodiments disclosed herein, any discussion of one particular form of multimedia data or data, shall be inclusive of any other type of multimedia data as defined above.

In accordance with certain embodiments of the present disclosure, methods disclosed herein may occur in “real-time.” Real-time is utilized herein as meaning near-instantaneous, subject to minor delays caused by network transmission and computer processing functions, and able to support various input and output data streams.

In many embodiments of the present disclosure, the systems and methods described herein largely occur as “double blind” methods, that is, one user has no access to another user's information provided within the system. Such a “double blind” procedure is highly important to obtain objective and honest information from each party during the resolution methods.

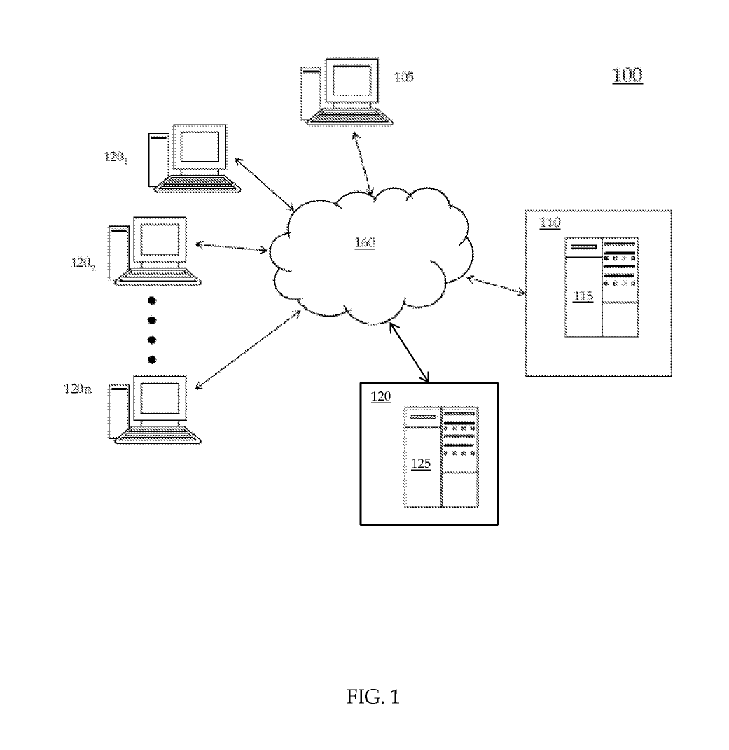

FIG. 1 depicts a system-level network diagram of a system of alternative dispute resolution in accordance with one embodiment of the present disclosure. The system 100 generally comprises at least a first user 105 and secondary users 120₁ and 120₂, each in communication with an administrator 110, generally hosting a central server 115 or database, through a network 160, which may comprise a global computer network, for example, the Internet.

As is common in network-based business models, the administrator 110 may also comprise a web administrator, responsible for providing and maintaining a website or interactive portal through which all of the users of the system 100 may interact and execute the methodology and functionality disclosed in the embodiments disclosed herein.

Although FIG. 1 explicitly depicts three secondary users (labeled “User 2” 120₁, “User 3” 120₂, and “User N” 120_{N}), it should be appreciated that N represents any number of users feasible in accordance with embodiments of the present disclosure. For ease of reference, as used herein, each of the terms “second user” or “secondary user” may refer to any one or all of the users 120₁, 120₂, and 120_{N} within the system 100. Likewise, although FIG. 1 explicitly depicts only one first user 105, there may be more than one first user 105 in accordance with certain embodiments of the present disclosure. That is, in certain embodiments, multiple users may perform the same or similar functions as the first user 105. As understood by embodiments of the present disclosure, a user may include any person, business or entity, capable of participating in the system and methods disclosed herein.

The first user 105 generally has a legal issue against another party and seeks to resolve such issue through an alternative dispute resolution process. The legal issue may be a litigious issue, contractual issue, transactional issue or the like. In many embodiments, the legal issue comprises a type of dispute which gives rise to fiscal liability, such that a financial settlement may be adequate remedy for the dispute. In another embodiment, the legal issue comprises a complex matter in which multiple parties may have contributed towards liability, and the scope of each parties' liability remains at issue. In a different embodiment, the first user 105 may have a potential legal issue, not yet ripe or prepared for court, but the first user 105 seeks to determine a potential likely outcome should a case proceed. In further embodiments, the first user 105 may comprise insurance carriers and self-insured entities with a financial interest in a legal dispute. In yet another embodiment, the first user 105 may comprise a third party claims administrator or the like.

The secondary user(s) 120 may also possess any of the same issues as the first user 105, and in certain embodiments, may be a party against whom the first user has such dispute. In accordance with embodiments of the present disclosure, any of the users may comprise the party at interest, such party's attorney, paralegal or legal assistant, or any other party with an actual or potential interest in a party's legal dispute.

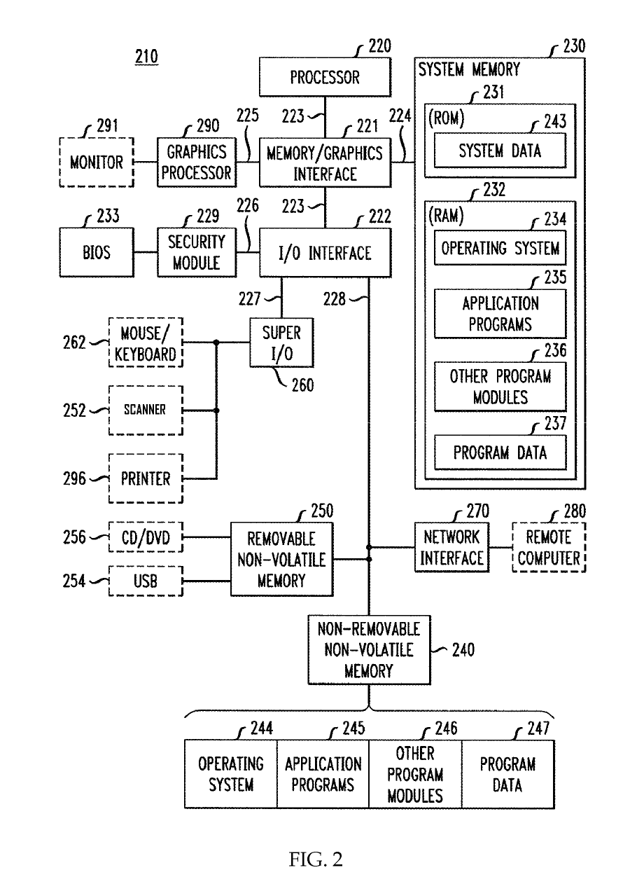

In a basic exemplary embodiment, within the system 100, a first user 105 may be capable of transmitting data regarding the event to the administrator 110, using a computing device. The computing device in the context of this application may include, but is not limited to a mobile device, a personal computer, smartphone, an Apple iPhone, a Blackberry device, Personal Data Assistant (PDA), a netbook, a mobile computer or the like, or may generally include a general purpose computer, or components thereof as discussed below in FIG. 2.

As explained above, the network 160 may comprise any network suitable for embodiments of the present disclosure. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

Optionally, a third party 120, generally hosting a commercial server 125 or database, may be in communication with the system 100 through the network 160 to carry out certain features of embodiments of the present disclosure, as explained below. In accordance with embodiments of the present disclosure, such third party commercial servers 125 may be administered by financial institutions (e.g., banks, credit card companies, or the like), advertisers (e.g., any third party offering banner ads or displayed offers), local merchants (e.g., providing information regarding an area or services within an area) social networking sites (e.g., Facebook, MySpace, Twitter, FourSquare or the like), global positioning system administrators, or the like.

In accordance with one embodiment of the present disclosure, any of the administrator or users may comprise a general purpose computer, for example, as shown in the form of a computer 210 depicted in FIG. 2. As appreciated by embodiments of the present disclosure, more practical devices, such as mobile devices, mobile telephones, laptop computers, netbooks, tablet computers, or the like, are likely to be utilized than a general computer 210 for embodiments of the present disclosure. However, it is also appreciated there is a significant similarly in core components between a mobile device, a personal computer, and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of peripherals, such as scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, touch screen, fax machine, modem, touch pad, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. Further, but other commonly known, components for mobile devices and personal computers may also be included in a general computer 210. For example, global positioning chips, wireless communication capability, and related technologies should be included within many embodiments of the present disclosure.

It is understood by embodiments of the present disclosure that a computer, such as the one depicted in FIG. 2, may be connected to a computer network or system. A computer network may include the Internet, a global computer network, a global positioning system, an internal computer network, dedicated server networks, or the like.

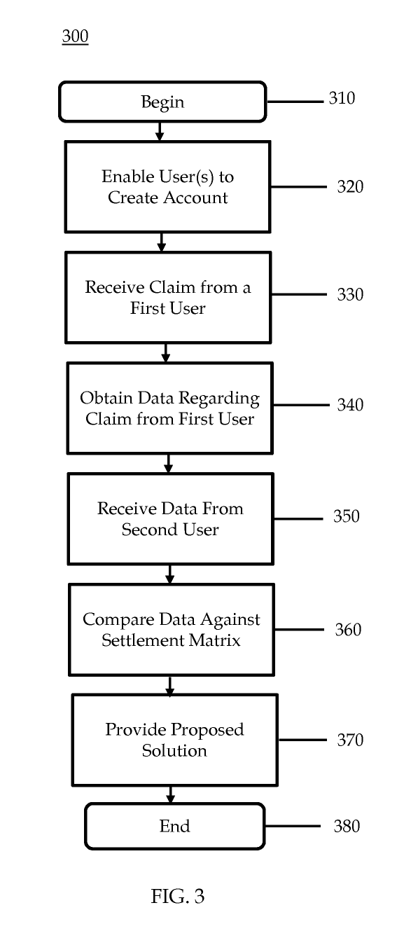

FIG. 3 depicts a flowchart of a method of alternative dispute resolution utilizing an exemplary embodiment in accordance with embodiments of the present disclosure. The exemplary method shown depicts a method of engaging users in alternative dispute resolution through a global computer network in accordance with one embodiment of the present disclosure. The method 300 begins as step 310.

At step 320, a plurality of user accounts are created by a plurality of users or entities connected to the system. Generally, each of the user accounts corresponding to one of the plurality of users or entities, whereby an entity may be an individual, organization, group, business, or other defined body, such as the first and seconds users described herein. Each of the user accounts comprises a plurality of uploadable features. For example, each of the user accounts may allow for uploading of entity-specific characteristics, including basic identification information, security information (e.g., a user name and password), or the like. Each of such user accounts are generally stored as files within a database at the administrator. In many embodiments, when creating a user account, such user may have to subscribe, or otherwise pay for access to the system.

At step 330, one of the users, for example, the first user, may present a legal claim to the system. In many embodiments, a claim is facts pertaining to an actual lawsuit, a notice of a lawsuit, the threat of a lawsuit or a speculative issue that may give rise to an issue of legal liability and/or damages. In receiving the claim, the administrator may assign the claim a unique file number for within the system. Such file number may match any of a court docket number, an attorney's file number, an arbitrary number assigned by the administrator, or the like.

In presenting the claim, the first user may be required to furnish sufficient information to create a data profile of the claim, independent of the legal matters at issue. For example, in one embodiment, a user may be required to identify the name and contact information of the actual or potential adversary and/or his/her legal counsel. In some embodiments, the information provided at this stage may be used to contact the adversary and notify him/her of the use of the system disclosed herein, and invite him/her to join the system to engage in the same.

At step 340, data is obtained from the first user regarding the legal matters and merits of the claim. For example, in one embodiment, a user may be required to provide nothing more than an objective opinion as to a likelihood of prevailing (by percentage), the amount of liability contributed by the first user (by percentage), and a full value range of damages (in dollar amount). In more complex embodiments, additional information, such as identification of any pertinent legal or factual disputes, any emerging areas of law, recent jurisprudence that may impact the case (whether authoritative or persuasive), or the like.

At step 350, data is obtained from the second user, similar to that obtained from the first user at step 340. As described above, such information is provided by the second user as part of a “double blind,” such that the information being provided is done on the second user's assessment and opinion only, with no access to the information provided by the first user. In the event there are multiple parties that may be liable and owe damages, any number of secondary users may provide their information at this stage.

At step 360, the data provided by all parties is compared against a settlement matrix. In one embodiment, to start, each party's information is assessed and a settlement number for that party is created. For example, based on the range of damages provided, a mid-point may be selected, which is then divided based upon the user's share of liability and then further reduced by the user's chances of prevailing. Such a calculation would provide that user's settlement number.

Once each party's settlement number is identified, the numbers are compared to determine if they are within an acceptable range to promote settlement. In one embodiment, the acceptable range may be 50% or less different. In another embodiment, the acceptable range may be within 25% or less different. In yet another embodiment, the acceptable range may be within 10% or less different. While any number of percentage ranges may be utilized, embodiments of the present disclosure only support reasonable variations between numbers suitable for likely settlement opportunity.

Rather than just considering the settlement numbers, in some embodiments, the system reviews the values provided by each party for the likelihood of success and/or damage values against one another. For example, if each party believes there is a low likelihood of success on the merits, the system may identify that each party is likely to settle as each believes losing the case is likely. Alternatively, in the event parties have damage values that overlap or are close, the value of the overall case may be deemed established, and the system may identify the parties need only resolve percentages of liability to resolve the case.

At step 370, in the event the numbers are within the acceptable range, or that certain parameters are acceptable, each party is notified that there is a likelihood of settlement and further discussion is recommended. However, in the event there is too much difference between the numbers, the parties may be notified that settlement discussions at this stage may be a waste of time. In many embodiments, a middle ground is also provided; for example, if the parties are close, but just outside the acceptable range, they may be asked to reconsider their numbers and change any other factors. Alternatively, the parties may be asked to revisit the system in a short amount of time, and provide updated information, perhaps after a significant legal issue in the dispute is resolved in a courtroom.

The exemplary method 300 ends at step 380.

In addition to the exemplary method shown, embodiments of the present disclosure may have numerous additional features to facilitate resolution of disputes. In one embodiment, the system may provide access to one or more experienced mediators which may be accessed for any one or part of the resolution process. In the event mediation is not successful, users may agree on a binding arbitration with High/Low agreements in place representing the calculations made during the ADR process described herein, or through some alternative means.

In another embodiment, to assist in resolution, users may agree to waive jurisdiction comparative fault and submit to a Pure Comparative Arbitration. In such an embodiment, a party found 90% at fault would still be entitled to recover at least 10% of total damages.

In many embodiments of the present disclosure, the system and methods described herein will cultivate data, as well as industry expertise, and store it in a database to help the users set reasonable expectations. For example, where a personal injury case arises, the system may initially be able to tap into local experts to determine suggested ranges for the upper and lower limits of settlement based upon the outcomes of similar cases. Such “reality check” may be a useful tool for each party to consider in framing a position within the system.

Once sufficient data is collected, such system will be less based on opinion and more on factual data amassed over time. As such, embodiments of the present disclosure may be able to provide information to a user, once a claim is initially received and/or during the entry of data from the user, to notify the user whether the information provided is reasonable in view of past results. By utilizing objective party data, and past resolutions of similar cases, reasonable settlements should be obtained much faster.

In numerous embodiments, it may be beneficial to break up data within geographical and/or legal segments. For example, an attorney who practices in Monmouth County, N.J. in personal injury cases may only need access to a system which provides her with information relevant to Monmouth County, N.J. personal injury cases. As such, the user may be provided with limited access to a system that solely works in that jurisdiction and in that area of law, and pay a subscription fee exclusively for that portion. In another example, an insurance company who insures commercial clients in all facets of their operations along the eastern seaboard may need access to a system that provides information regarding corporate legal issues across several jurisdictions.

In many embodiments of the present disclosure, the systems and methods described herein may include a means of predicting and/ or limiting Medicare lien exposure. Medicare liens may be placed on a personal injury case, or another type of case, involving a person whose treatment is at least partially paid by Medicare. In some instances, an estimate is provided by Medicare of the funds that would not have been paid without the subject accident or incident. This estimate is sometimes inaccurate, and therefore may subject a settling entity to further exposure from Medicare liens. In some embodiments, a means of predicting and/or limiting Medicare lien exposure may include providing insurance coverage to protect entities who settle claims with Medicare claimants. The insurance coverage option may be presented to users as part of a settlement process and transmitted or displayed to users on a computing device. The computing device may be configured to allow users to purchase an insurance policy to cover the user in the event the user is subject to exposure from a Medicare lien. In some embodiments, Medicare lien data may be stored in a database to enable a user to better predict Medicare lien exposure by providing an exposure estimate or range of estimates, thereby allowing a user to better select an insurance policy that covers the lien exposure.

In many embodiments, the systems and methods described herein may comprise the ability to digitally execute a release on a computing device. In embodiments, a computing device may be configured to allow a user to digitally execute a release or allow a user to select an option that the user agrees to a release. When a release is digitally signed or an agreement option has been selected by both parties, the release may be fully executed. In some embodiments, when a release is fully executed, a computing device may be configured to allow for and/or facilitate a transfer of funds between parties or accounts. By way of example, in some embodiments, when a release is fully executed a computing device may be configured to facilitate a wire transfer of funds, an electronic transfer of funds, a physical transfer of funds, and/or the like. In some embodiments, a computing device may also be adapted to allow a user to apply for an insurance policy, such as an insurance policy to cover exposure to Medicare liens. In some embodiments, a computing device may be configured to allow the parties or an insuring entity to negotiate a Medicare Lien compromise on behalf of one of the parties or the insuring entity.

While the foregoing is directed to exemplary embodiments of the present disclosure, other and further embodiments of the disclosure may be devised without departing from the basic scope thereof, and should be considered part of this disclosure, as if described fully herein. Specifically, whereas the worldwide web and mobile web are growing content and capabilities at ever-increasing rates, the ability to adapt the systems, methods, applications, and interfaces disclosed herein to existing or new mobile- or web-based technology is contemplated by embodiments of the present disclosure and does not depart the scope of the disclosure disclosed herein.

What is claimed is:

1. A computer-implemented method for alternative dispute resolution, the method comprising:
at a computing device having one or more processors and memory storing one or more programs for execution by the one or more processors:
receiving a legal claim and an associated data profile from a first user;
receiving first user merit data from the first user, the first user merit data comprising data associated with the merits of the legal claim;
receiving second user merit data from a second user, the second user merit data comprising data associated with the merits of the legal claim;
generating a settlement number for the first user based on the first user merit data;
generating a settlement number for the second user based on the second user merit data; and
notifying the first user and the second user that settlement is likely if the settlement number for the first user and the settlement number for the second user are within an acceptable range.

2. The method of claim 1, further comprising:
notifying the first user and the second user that settlement is not likely if the settlement number for the first user and the settlement number for the second user are not in the acceptable range.

3. The method of claim 1, wherein the legal claim comprises at least one of a fact pertaining to a lawsuit, a notice of a lawsuit, the threat of a lawsuit, and a speculative issue.

4. The method of claim 1, further comprising:
generating and storing a first user account associated with the first user and a second user account associated with the second user, wherein at least one of the first user and the second user is required to submit payment and activate a subscription to be granted access to the method.

5. The method of claim 1, wherein the data profile comprises at least one of contact information for a user and contact information of the user's legal counsel, wherein the data profile may be used to automatically contact at least one of a user and a user's legal counsel when a legal claim is received.

6. The method of claim 1, further comprising, at the computing device:
granting access to the first user merit data only to the first user; and
granting access to the second user merit data only to the second user.

7. The method of claim 1, wherein the merit data comprises at least one of a percent likelihood of prevailing, a percentage of liability contributed by the first user, and a range of potential damages.

8. The method of claim 1, wherein the first user merit data and the second user merit data comprises at least one of an identification of pertinent legal and factual disputes, an identification of pertinent emerging areas of law, and an identification of recent relevant jurisprudence.

9. The method of claim 1, wherein the settlement number generation comprises:
selecting a mid-point number in a range of damages received from a user;
dividing the mid-point number based upon the user's share of liability and generating a divided damages number; and
reducing the divided damages number based on the user's chances of prevailing.

10. The method of claim 1, wherein the acceptable range comprises at least one of less than 50% different, less than 25% different, and less than 10% different.

11. The method of claim 1, further comprising, at the computing device:
comparing the first user merit data and the second user merit data and notifying the first user and the second user that settlement is likely based on the comparison of the first user merit data and the second user merit data.

12. The method of claim 1, further comprising:
comparing the first user merit data and the second user merit data and notifying the first user and the second user that settlement is not likely based on the comparison of the first user merit data and the second user merit data.

13. The method of claim 1, further comprising:
notifying at least one of the first user and the second user that at least one of the first user and the second user should reconsider their settlement position if at least one of the settlement number for the first user and the settlement number for the second user are within a percentage of the acceptable range.

14. The method of claim 1, further comprising:
allowing the first user and the second user direct access to a mediator.

15. The method of claim 1, further comprising:
allowing the first user and the second user to agree to binding arbitration based upon the settlement number for the first user and the settlement number for the second user; and
allowing the first user and the second user to agree to waive jurisdiction and comparative fault, and submit to a pure comparative arbitration.

16. The method of claim 1, further comprising:
providing a range of suggested settlement numbers to the first user and the second user, the range of suggest settlement numbers based upon at least one of the outcome of similar cases and the opinion of a local expert.

17. The method of claim 1, further comprising:
providing a range of suggested settlement numbers to the first user when a legal claim is received based on data related to the legal claim previously collected from other users.

18. The method of claim 17, wherein the data related to the legal claim comprises data collected from cases within a geographical area and an area of law.

19. A computer-implemented method for alternative dispute resolution, the method comprising:
at a computing device having one or more processors and memory storing one or more programs for execution by the one or more processors:
generating and storing a first user account associated with a first user and a second user account associated with a second user, wherein at least one of the first user and the second user is required to submit payment and activate a subscription in order to access the method;
receiving a legal claim and an associated data profile from the first user;
receiving first user merit data from the first user, the first user merit data comprising data associated with the merits of the legal claim;
receiving second user merit data from the second user, the second user merit data comprising data associated with the merits of the legal claim;
granting access to the first user merit data only to the first user;
granting access to the second user merit data only to the second user
generating a settlement number for the first user based on the first user merit data;
generating a settlement number for the second user based on the second user merit data;
notifying the first user and the second user that settlement is likely if the settlement number for the first user and the settlement number for the second user are within an acceptable range; and
notifying the first user and the second user that settlement is not likely if the settlement number for the first user and the settlement number for the second user are not in the acceptable range.

20. A computer-implemented method for alternative dispute resolution, the method comprising:
at a computing device having one or more processors and memory storing one or more programs for execution by the one or more processors:
receiving a legal claim and an associated data profile from a first user;
providing a range of suggested settlement numbers to the first user based on data related to the legal claim previously collected from other users;
receiving first user merit data from the first user, the first user merit data comprising data associated with the merits of the legal claim;
receiving second user merit data from a second user, the second user merit data comprising data associated with the merits of the legal claim;
generating a settlement number for the first user based on the first user merit data;
generating a settlement number for the second user based on the second user merit data;
notifying the first user and the second user that settlement is likely if the settlement number for the first user and the settlement number for the second user are within an acceptable range;
notifying the first user and the second user that settlement is not likely if the settlement number for the first user and the settlement number for the second user are not in the acceptable range; and
notifying at least one of the first user and the second user that at least one of the first user and the second user should reconsider their settlement position if the settlement number for the first user and the settlement number for the second user are within a percentage of the acceptable range.
